(19) United States
(12) Patent Application Publication
(10) Pub. No.: US 2024/0416676 A1
(43) Pub. Date: Dec. 19, 2024

(54) HIGH-PRESSURE LAMINATE PANEL

(71) Applicant: Keding Enterprises Co., Ltd, New Taipei City 241561 (TW)

(72) Inventor: Hsien-Chang Tsao, New Taipei City 241561 (TW)

(21) Appl. No.: 18/604,645

(22) Filed: Mar. 14, 2024

(30) Foreign Application Priority Data
Jun. 17, 2023 (TW) 112206221

(51) Int. Cl. B44F 9/00; B32B 27/10; B32B 27/12; B32B 27/28; B32B 27/36

(52) U.S. Cl. CPC B44F 9/00; B32B 27/10; B32B 27/12; B32B 27/28; B32B 27/36; B32B 2250/02; B32B 2307/4023; B32B 2307/7376; B32B 2451/00

(57) ABSTRACT

A high-pressure laminate (HPL) panel includes a bottom layer and a printed homochromatic layer. The bottom layer functions as a base, and the printed homochromatic layer is disposed on the bottom layer. With the sophisticated structure configuration, an edge and a panel surface of the HPL panel are blended into a same color, thereby achieving a borderless visual effect. Also, only the direct glue application is needed during construction due to its light, handy and rollable properties, so that the decoration process becomes time-saving, simple and cost saving. The advanced flexibility makes the product, having the affordable price, be attached to various types of curved surfaces or irregular surfaces, and be applicable to various indoor and outdoor surfaces, thereby enhancing the utility and the willingness of use.

### BACKGROUND OF THE INVENTION

### (1) Field of the Invention

The invention relates to an improved high-pressure laminate (HPL) panel, and more particularly to an improved structure of a HPL panel having light, handy and rollable properties, so that only the direct glue application is needed during construction, and that the decoration process becomes time-saving, simple and cost saving. The advanced flexibility makes the product, having the affordable price, be attached to various types of curved surfaces or irregular surfaces, and be applicable to various indoor and outdoor surfaces, thereby enhancing the utility and the willingness of use.

(2) Description of Related Art

The HPL panel is one of common materials in the home decoration, and is used on the wall, the ceiling and the kitchen countertop. In addition, the price of the HPL panel is cheaper than that of each of the stone and brick, and can imitate textures of marble, solid wood grains and the like through the processing technology.

First, the HPL panel is made of decorative colored paper and kraft paper, which are impregnated with special resin and are stacked in a layer-by-layer manner, and encounters high-temperature and high-pressure processing and processes including drying and the like. Because the HPL panel has various colors and needs not to be painted after adhering, the HPL panel is widely used as surface materials of various door pieces, countertops and the like.

Secondly, the HPL panel has the dirt resistant, scratch resistant and easy-to-clean properties, and this makes it become a first choice of material for the germaphobe. Because the HPL panel has few surface pores and pits, cannot hide dirt, and can withstand most weak acid and alkali cleaners and contamination of food, the HPL panel has been widely applied to kitchen countertops, tables, chairs, door pieces, cupboards, walls and the like.

Furthermore, there are various style choices of the HPL panel. In addition to the single color, the HPL panel further includes wood grains, stone textures, metal textures and the like, and has the prices varying by styles.

In terms of cleaning, the HPL panel has the property of not easily absorbing dirt, so the cleaning process is very simple, and only the damp cloth or mild detergent needs to be used to wipe the panel. However, tools, such as a steel brush, sand paper and the like, which may scratch the panel, need to be avoided, and the acidic cleaner needs to be avoided because the acidic cleaner may erode the surface of the HPL panel, and thus shorten the service lifetime thereof.

However, although the HPL panel has scratch resistant, wear resistant and flame resistant effects after the special surface treatment, it cannot withstand the high temperature and cannot resist the acid and alkali because it is constituted by special resin and paper materials. Special attention is required upon using to prevent the burnt surface caused by the high temperature, wherein the burnt surface is irreversible.

In addition, the adhesive also needs to be chosen carefully. The HPL panel swells easily when being exposed to water. If the liquid adhesive is used during construction, then the wall may become uneven and not tightly connected, and have gaps, and encounter other conditions. Therefore, it is recommended to soak the back side into water before construction to ensure the construction stability. Meanwhile, the harmless, pollution-free and low-formaldehyde adhesive needs to be chosen, and ventilation is required for two months after the construction is completed before living in the room.

To sum up, because the HPL panel has the advantages of durability, diverse styles, and affordable price, it has become a common material for many home decorations. However, like all building materials, attention also needs to be paid upon using, and proper care needs to be made to ensure the durability thereof.

Although the HPL panel has the above-mentioned properties, the edges of the existing HPL panel are black, a visible black border becomes too unexpected and unsightly, the conventional HPL panel cannot be easily attached to the curved surface or irregular surface, and the installation is less convenient, so the current application range of the HPL panel is limited. Therefore, how to solve the above-mentioned conventional problems and drawbacks is the direction that the present inventor and those skilled in the art want to research and improve urgently.

### SUMMARY OF THE INVENTION

Therefore, the present inventor has collected relevant information, evaluated and considered many parties, and thus developed and designed the present invention to solve the above-mentioned drawbacks according to many years of experience in this filed through continuous trial production and modification.

An objective of the invention is to provide a sophisticated structure configuration of an improved structure of a high-pressure laminate (HPL) panel, so that an edge and a panel surface of the HPL panel are blended into a same color, the HPL panel has the excellent penetrability and thus the borderless visual effect, and the overall structure of the HPL panel appears to be more distinct and beautiful. Also, only the direct glue application is needed during construction due to its light, handy and rollable properties, so that the decoration process becomes time-saving, simple and cost saving. The advanced flexibility makes the product, having the affordable price, be attached to various types of curved surfaces or irregular surfaces, and be applicable to various indoor and outdoor surfaces, thereby enhancing the utility and the willingness of use.

To achieve the above-identified or other objectives, the invention provides a high-pressure laminate panel including: a bottom layer functioning as a base; and a printed homochromatic layer disposed on the bottom layer.

In one preferred embodiment, a material of the bottom layer includes impregnated bottom paper or non-woven cloth.

In one preferred embodiment, a thickness of the bottom layer ranges between 0.05 mm and 0.3 mm.

In one preferred embodiment, a thickness of the bottom layer ranges between 0.1 mm and 0.25 mm.

In one preferred embodiment, a thickness of the bottom layer ranges between 0.15 mm and 0.2 mm.

In one preferred embodiment, one side of the bottom layer is directly adhered to a surface by way of glue application.

In one preferred embodiment, a material of the printed homochromatic layer includes polyethylene terephthalate glycol (PETG) or acrylonitrile butadiene styrene (ABS).

In one preferred embodiment, a thickness of the printed homochromatic layer ranges between 0.2 mm and 0.8 mm.

In one preferred embodiment, a thickness of the printed homochromatic layer ranges between 0.3 mm and 0.7 mm.

In one preferred embodiment, a thickness of the printed homochromatic layer ranges between 0.4 mm and 0.6 mm.

In one preferred embodiment, a surface of the printed homochromatic layer is printed with one of highly realistic wood grain, stone texture, monochrome portion and color portion.

### BRIEF DESCRIPTION OF DRAWINGS

FIG. 1 is a pictorial view showing an improved structure of a HPL panel according to a preferred embodiment of the invention.

FIG. 2 is a pictorially exploded view showing the improved structure of the HPL panel according to the preferred embodiment of the invention.

FIG. 3 is a side view showing the improved structure of the HPL panel according to the preferred embodiment of the invention.

FIG. 4 is a first schematic implementation view showing the improved structure of the HPL panel according to the preferred embodiment of the invention.

FIG. 5 is a second schematic implementation view showing the improved structure of the HPL panel according to the preferred embodiment of the invention.

### DETAILED DESCRIPTION OF THE INVENTION

In order to achieve the above-mentioned objectives and effects, the technical means and structures adopted in this invention are described in detail below with reference to drawings of the preferred embodiment of this invention to facilitate a complete understanding to this invention.

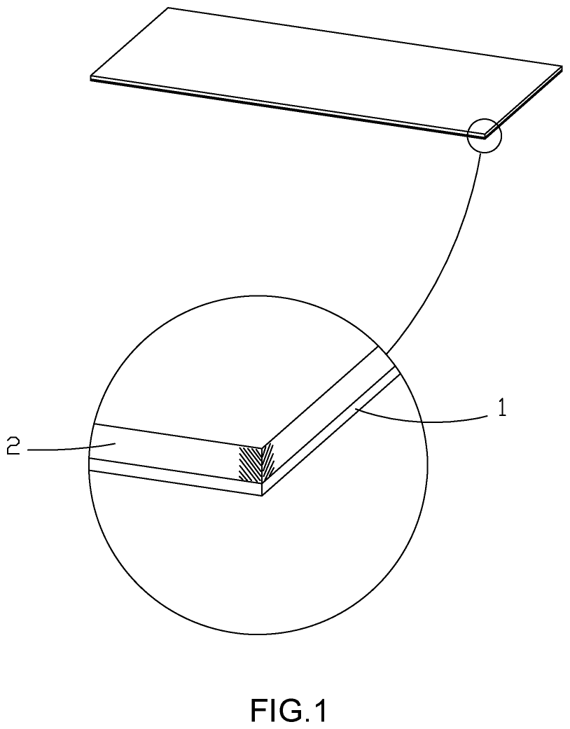

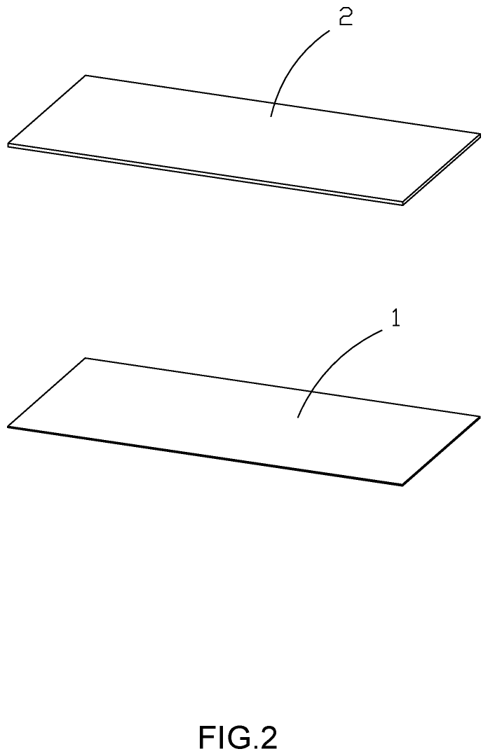

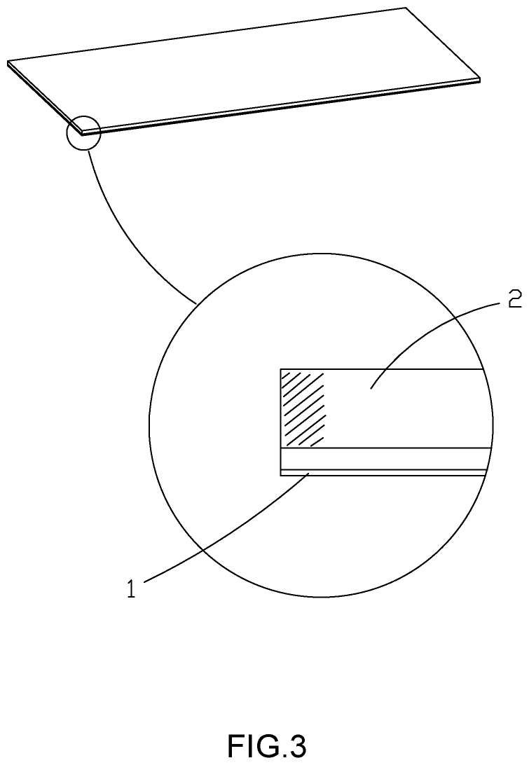

FIGS. 1 to 3 are a pictorial view, a pictorially exploded view and a side view showing an improved structure of a HPL panel according to a preferred embodiment of the invention. Referring to FIGS. 1 to 3, the HPL panel according to the preferred embodiment of the invention includes a bottom layer 1 and a printed homochromatic layer 2.

The bottom layer 1 functions as a base. Preferably, a material of the bottom layer 1 includes impregnated bottom paper or non-woven cloth, and a thickness of the bottom layer 1 ranges between 0.05 mm and 0.3 mm, between 0.1 mm and 0.25 mm, or between 0.15 mm and 0.2 mm. One side of the bottom layer 1 may be directly adhered to a surface by way of glue application.

The printed homochromatic layer 2 is disposed on the bottom layer 1. Preferably, a material of the printed homochromatic layer 2 includes polyethylene terephthalate glycol (PETG) or acrylonitrile butadiene styrene (ABS), and a thickness of the printed homochromatic layer 2 ranges between 0.2 mm and 0.8 mm, between 0.3 mm and 0.7 mm or between 0.4 mm and 0.6 mm. A surface of the printed homochromatic layer 2 is printed with one of a highly realistic wood grain, a stone texture, a monochrome portion and a color portion.

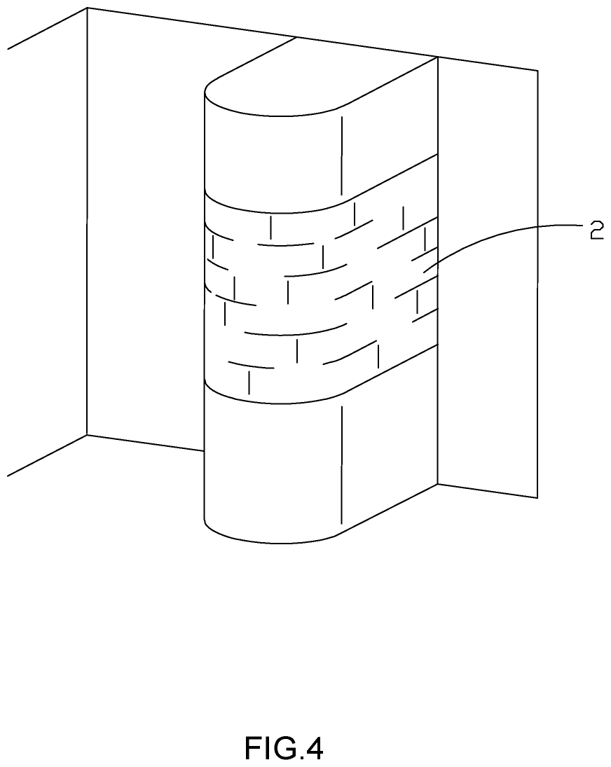

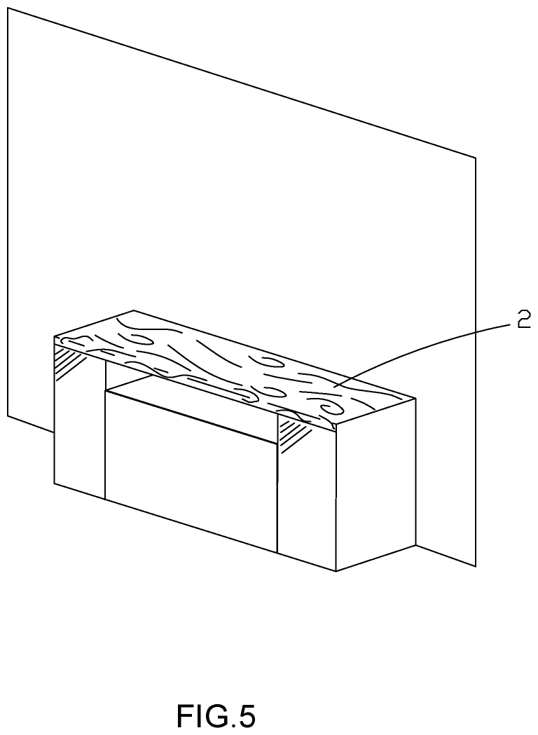

Operation conditions of the invention will be explained in the following according to the above-mentioned structure and composition design. FIGS. 4 and 5 are first and second schematic implementation views showing the improved structure of the HPL panel according to the preferred embodiment of the invention. Referring also to FIGS. 4 and 5, it can be clearly seen that the improved structure of the HPL panel of the invention has the light, handy and rollable properties, and can be installed onto the curved wall surface. During construction, only the direct glue application to the bottom layer 1 is needed, and the construction convenience is enhanced. Also, the improved structure of the HPL panel of the invention can be installed on the desktop, such as a tea table, a television stand, a dining table and the like, and the construction becomes very convenient.

It is necessary to specify that the improved structure of the HPL panel of the invention has the following advantages.

The convenience is obtained. The bottom layer 1 is made of the impregnated bottom paper or non-woven cloth material, can be rolled up like a sheet upon transportation, and has the extremely light weight. So, it is unnecessary to occupy a large carrying space and expend a lot of efforts. The on-site construction can be performed by way of direct glue application. So, it is time-saving and can be operated easily, it is more convenient upon furnishing, and the time and cost can be saved.

Third, the utility is obtained. After the layers have been combined, the product becomes highly flexible, and can be easily adhered to various curved surfaces or irregular surfaces including concave surfaces, convex surfaces and curved surfaces used indoors or outdoors, so that the construction is not restricted, the price is affordable, the willingness of use is increased, and the decoration practicality is improved.

So, referring to all the drawings, the invention in use indeed has the following advantages when compared with the prior art. The improved structure of the HPL panel of the invention has the light, handy and rollable properties, and only the direct glue application is needed during construction, so that the decoration process becomes time-saving, simple and cost saving. The advanced flexibility makes the product, having the affordable price, be attached to various types of curved surfaces or irregular surfaces, and be applicable to various indoor and outdoor surfaces, thereby enhancing the utility and the willingness of use.

However, the descriptions are made with reference to only the preferred embodiment of the invention without limiting the claims of the invention. Therefore, any simple modifications and equivalent structural changes made according to the descriptions and drawings of the invention are still deemed as falling within the scope of the invention.

What is claimed is:

1. A high-pressure laminate (HPL) panel, comprising:
a bottom layer functioning as a base; and
a printed homochromatic layer disposed on the bottom layer.

2. The HPL panel according to claim 1, wherein a material of the bottom layer comprises impregnated bottom paper or non-woven cloth.

3. The HPL panel according to claim 1, wherein a thickness of the bottom layer ranges between 0.05 mm and 0.3 mm.

4. The HPL panel according to claim 3, wherein the thickness of the bottom layer ranges between 0.1 mm and 0.25 mm.

5. The HPL panel according to claim 4, wherein the thickness of the bottom layer ranges between 0.15 mm and 0.2 mm.

6. The HPL panel according to claim 1, wherein one side of the bottom layer is directly adhered to a surface by way of glue application.

7. The HPL panel according to claim 1, wherein a material of the printed homochromatic layer comprises polyethylene terephthalate glycol (PETG) or acrylonitrile butadiene styrene (ABS).

8. The HPL panel according to claim 1, wherein a thickness of the printed homochromatic layer ranges between 0.2 mm and 0.8 mm.

9. The HPL panel according to claim 1, wherein a thickness of the printed homochromatic layer ranges between 0.3 mm and 0.7 mm.

10. The HPL panel according to claim 8, wherein the thickness of the printed homochromatic layer ranges between 0.4 mm and 0.6 mm.

11. The HPL panel according to claim 1, wherein a surface of the printed homochromatic layer is printed with one of a highly realistic wood grain, a stone texture, a monochrome portion and a color portion.
